(19) United States
(12) Patent Application Publication
(10) Pub. No.: US 2022/0130157 A1
(43) Pub. Date: Apr. 28, 2022

(54) VIDEO PROCESSING

(71) Applicant: Cookpad Ltd., Bristol (GB)

(72) Inventors: Ammar ZAHER, Bristol (GB); Aki SANO, Bristol (GB)

(21) Appl. No.: 17/571,173

(22) Filed: Jan. 7, 2022

Related U.S. Application Data
(63) Continuation of application No. PCT/GB2020/051640, filed on Jul. 8, 2020.

(30) Foreign Application Priority Data
Jul. 10, 2019 (GB) 1909919.1

(51) Int. Cl. G06V 20/68; G06T 7/70; G06V 40/20; G06V 10/25; G10L 15/22; G06V 20/40

(52) U.S. Cl. CPC G06V 20/68; G06T 7/70; G06V 20/44; G06V 10/25; G10L 15/22; G06V 40/28

(57) ABSTRACT

A method of assisting a user in preparation of food. The method comprises capturing a video of the user performing one or more steps in the preparation; generating, from the captured video, a machine representation of the performed one or more steps; comparing the generated machine representation to a corpus of one or more pre-existing machine representations, the one or more pre-existing machine representations corresponding to one or more pre-existing videos; based on the comparison, identifying at least one pre-existing machine representation in the corpus which has a similarity relationship with the generated machine representation; and facilitating playback to the user of at least one pre-existing video corresponding to the identified at least one pre-existing machine representation.

### CROSS-REFERENCE TO RELATED APPLICATIONS

This Application is a continuation of PCT Application No. PCT/GB2020/051640, filed Jul. 8, 2020, which claims priority to United Kingdom Application No. 1909919.1, filed Jul. 10, 2019, the entire contents of each of which are incorporated herein by reference.

### INTRODUCTION

### Technical Field

The present disclosure concerns video processing. More particularly, but not exclusively, this disclosure concerns means of video processing to extract from a captured video one or more actions performed in the captured video and to subsequently identify one or more pre-existing videos corresponding to the extracted actions.

### Background

When learning to perform a task, a learner can often find it beneficial to view videos of another person performing the task. The videos provide the learner with examples to follow, and allow the learner to compare and check their own technique for performing the task against that of a more experienced person. When learning to cook for example, a learner may view a video of another, more experienced, person performing a recipe or a step in the preparation of food, before attempting to perform the recipe or step themselves. During performance of the recipe or step, the learner may encounter difficulty or find themselves uncertain of their technique in the performance of that step or their current stage of the recipe. In such a situation, the learner may opt to re-watch a part of the video corresponding to the step or to a current stage of the recipe.

However, it is not always easy for a learner to identify video content that they can use for such a purpose. For example, video content showing a particular step or recipe stage with which the learner is struggling may be a small part of a much longer video. It is not always easy for the learner to identify that the video contains the relevant part, let alone for them to subsequently find that part within the video. In other instances, the learner may not be sufficiently well versed in the task to allow them to adequately define or describe for the purposes of a text-based search the step or recipe stage with which they are struggling.

The present disclosure seeks to mitigate the above-mentioned problems. Alternatively or additionally, the present disclosure seeks to provide improved measures for identifying and presenting relevant video content to a learner.

### SUMMARY

According to a first aspect of the present disclosure there is provided a method of assisting a user in preparation of food, the method comprising: capturing a video of the user performing one or more steps in the preparation; generating, from the captured video, a machine representation of the performed one or more steps; comparing the generated machine representation to a corpus of one or more pre-existing machine representations, the one or more pre-existing machine representations corresponding to one or more pre-existing videos; on the basis of the comparison, identifying at least one pre-existing machine representation in the corpus which has a similarity relationship with the generated machine representation; and facilitating playback to the user of at least one pre-existing video corresponding to the identified at least one pre-existing machine representation.

According to a second aspect of the present disclosure there is provided a system for assisting a user in preparation of food, the system comprising: a camera, configured to capture a video of the user performing one or more steps in the preparation; a processing system, configured to generate, from the captured video, a machine representation of the performed one or more steps, compare the generated machine representation to a corpus of one or more pre-existing machine representations, the one or more pre-existing machine representations corresponding to one or more pre-existing videos, and, on the basis of the comparison, identify at least one pre-existing machine representation in the corpus which has a similarity relationship with the generated machine representation; a display, configured to facilitate playback to the user of at least one pre-existing video corresponding to the identified at least one pre-existing machine representation.

According to a third aspect of the present disclosure there is provided a computer program comprising a set of instructions, which, when executed by a computerized device, cause the computerized device to perform a method of assisting a user in preparation of food, the method comprising: capturing a video of the user performing one or more steps in the preparation; generating, from the captured video, a machine representation of the performed one or more steps; comparing the generated machine representation to a corpus of one or more pre-existing machine representations, the one or more pre-existing machine representations corresponding to one or more pre-existing videos; on the basis of the comparison, identifying at least one pre-existing machine representation in the corpus which has a similarity relationship with the generated machine representation; and facilitating playback to the user of at least one pre-existing video corresponding to the identified at least one pre-existing machine representation.

It will of course be appreciated that features described in relation to one aspect of the present disclosure may be incorporated into other aspects of the present disclosure. For example, the method of the present disclosure may incorporate any of the features described with reference to the apparatus of the present disclosure and vice versa.

### DESCRIPTION OF THE DRAWINGS

Embodiments of the present disclosure will now be described by way of example only with reference to the accompanying schematic drawings of which:

FIG. 1 shows a block diagram of a system according to embodiments of the present disclosure; and

FIG. 2 shows a flow chart illustrating the steps of a method according to embodiments of the present disclosure.

### DETAILED DESCRIPTION

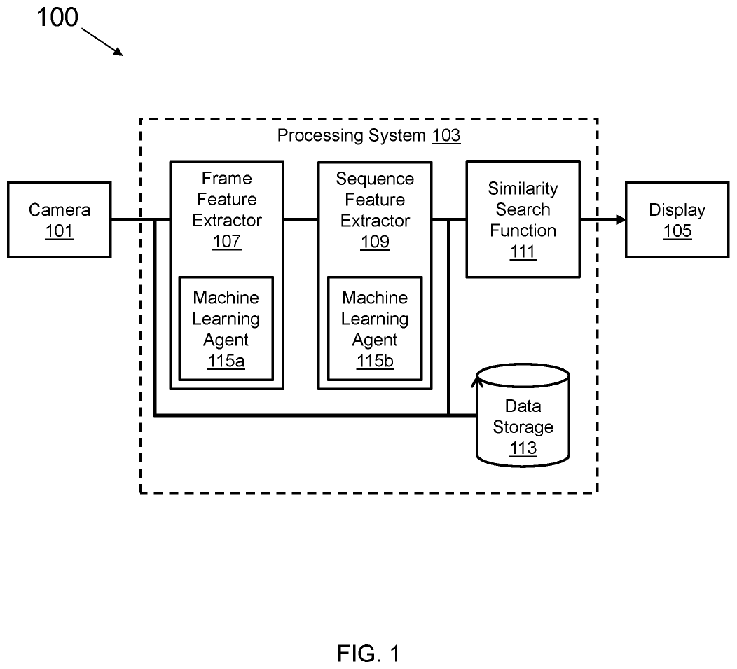

FIG. 1 shows a block diagram of a system 100 for assisting a user in preparation of food according to embodiments of the present disclosure. The user may use system 100 in order to assist them in learning how to cook. The user may therefore be referred to as a ‘learner’. System 100 comprises a camera 101, processing system 103, and a display 105. Display 105 may for example comprise a computer monitor, a touch screen, tablet computer, or a television. Alternatively, display 105 may comprise a graphical user interface (GUI). In embodiments, camera 101 and display 105 are comprised in a single unit or device. In such embodiments, the unit may, for example, comprise a tablet, laptop, or desktop computer having a webcam. Camera 101 and display 105 are each connected to processing system 103. In embodiments, multiple cameras 101 may be employed, for example to capture video from different angles, at different resolutions, etc.

Processing system 103 may comprise one or more processors configured to process instructions and/or data.

In embodiments, processing system 103 comprises data storage 113. Data storage 113 is configured to store information and/or instructions for use by the one or more processors.

It will be appreciated by a person skilled in the art that processing system 103 may be provided by a local processing node comprised in one or more of camera 101, display 105, and a further unit, or may be provided by a remote processing resource, for example a remote server or cloud computing service. Thus, the connections between processing system 103 and each of camera 101 and display 105 may be provided over a network, for example over a packet-switched network such as the internet. Similarly, processing system 103 may be located in a single location or may be distributed in multiple locations. In embodiments, processing system 103 is provided by a combination of a local processing node and a remote server. In some embodiments, computationally complex tasks are performed on the remote server. In some embodiments, the local processing node is configured to perform pre-processing of data to reduce the quantity of data required to be transmitted to the remote server.

In embodiments, camera 101 is arranged to view a work surface, upon which a user may prepare food. Camera 101 is configured to capture a video of the user performing one or more steps in the preparation, and to transmit the captured video to processing system 103. In embodiments, the captured video is stored in data storage 113. In embodiments, the captured video is stored in an additional separate memory. In embodiments, the captured video is stored on a remote network accessible location. For example, the captured video may be stored on a remote server accessible via the internet.

In embodiments, system 100 is configured to detect a trigger event. In embodiments, camera 101 is configured to capture a video in response to detecting the trigger event. In embodiments, the trigger event comprises a predetermined phrase spoken by the user. In embodiments, system 100 comprises a microphone capable of detecting audio signals such as speech of the user. In embodiments, the microphone is comprised in camera 101. In alternative embodiments, the microphone is comprised in display 105. In embodiments, the trigger event comprises the user providing user input on camera 101 or display 105. In embodiments, camera 101 is configured to detect the trigger event. In alternative embodiments, display 105 is configured to detect the trigger event and to transmit to camera 101 an indication that the trigger event has been detected.

Processing system 103 is configured to receive the captured video from camera 101 into a frame feature extractor 107. Frame feature extractor 107 is configured to process individual frames of the captured video to extract features contained within those frames. In embodiments, frame feature extractor 107 is configured to process every frame of the captured video. In alternative embodiments, frame feature extractor 107 is configured to process a selection of the frames of the captured video. In such alternative embodiments, frame feature extractor 107 may be configured to process frames captured at regular intervals, for example every tenth frame of the captured video. Processing a reduced selection of frames from the captured video reduces the processing resources and/or time required to perform frame feature extraction on the captured video.

In embodiments, processing system 103 is configured to perform at least one image recognition process on the captured video. In embodiments, the at least one image recognition process comprises one or both of hand detection and object detection. Thus, in embodiments, frame feature extractor is configured to perform hand detection and the extracted features comprise one or both hands of a user. In embodiments, frame feature extractor is configured to perform object detection and the extracted features comprise objects, for example cooking utensils and/or ingredients. Frame feature extractor 107 outputs frame feature data defining for each of the processed frames the features extracted.

Sequence feature extractor 109 is configured to receive and process the frame feature data output by frame feature extractor 107. It will be appreciated by a person skilled in the art that the frame feature data corresponds to a plurality of frames, and that those frames comprise a sequence of frames in the captured video. It will also be appreciated that the sequence need not necessarily comprise consecutive frames in the captured video. Sequence feature extractor 109 is configured to process the sequence of frames to extract features contained within the sequence. It will be understood by a person skilled in the art that a sequence of frames may comprise further features that are not comprised in the constituent frames in isolation, for example where the feature relates to a change or difference between two frames. In embodiments, the sequence corresponds to the entirety of the frame feature data. In alternative embodiments, the sequence corresponds to a selection of the frame feature data.

By tracking a change in position of a detected feature between the frames in the sequence, sequence feature extractor 109 can determine a movement of the detected feature. In embodiments, sequence feature extractor 109 is configured to perform hand and/or object tracking and the extracted features comprise movements of one or both of detected hands and detected objects. From the movements of detected hands and/or objects, it is possible to determine an action being performed.

For example, frame feature extractor 107 may detect a bowl, a hand of the user, and a spoon held by the user. Sequence feature extractor 109 may then identify a circular movement of the user's hand and the spoon within the bowl. On the basis of these detected features, sequence feature extractor 109 may further determine that the user is performing an action of stirring the contents of the bowl.

In another example, frame feature extractor 107 may detect a chopping board, the hands of the user, a knife held in a first hand of the user, and a carrot held against the chopping board by the second hand of the user. Sequence feature extractor 109 may then identify repeated movement of the knife lengthways across the width of the carrot. On the basis of these detected features, sequence feature extractor 109 may further determine that the user is performing an action of chopping a carrot.

In embodiments, sequence feature extractor 109 is configured to perform action detection and the extracted features comprise one or more actions. It will be appreciated by a person skilled in the art that the actions detected will correspond to the performed one or more steps in the preparation. Thus, in embodiments, the at least one image recognition process comprises one or both of hand tracking and action detection.

Thus, sequence feature extractor 109 is configured to generate sequence feature data defining the features extracted from the sequence of frames. The sequence feature data can be considered to be a machine representation of the performed one or more steps in the preparation. Thus, the output of sequence feature extractor 109 is a machine representation of the performed one or more steps. In embodiments, the machine representation comprises an array of vectors. In embodiments, sequence feature extractor 109 is configured to normalize the array of vectors.

In embodiments, one or both of frame feature extractor 107 and sequence feature extractor 109 comprise a machine learning agent 115a, 115b. Thus, in embodiments, generating a machine representation of the performed one or more steps comprises operating machine learning agents 115a, 115b. In embodiments, machine learning agents 115a, 115b will, prior to the capturing of the video, have undergone one or both of supervised and unsupervised training using a plurality of videos and/or images of food preparation. Machine learning techniques, including supervised and unsupervised training, are well known to those skilled in the art and therefore will not be discussed in further detail here. It will be appreciated that processing system 103 may be provided wholly or partially by a remote computing resource, and therefore that machine learning agents 115a, 115b may be stored/implemented on a remote computing resource. In embodiments, machine learning agents 115a, 115b are stored in data storage 113. Furthermore, it will be appreciated that the training of machine learning agents 115a, 115b may therefore take place on a remote computing resource.

Thus, processing system 103 is configured to generate, from the captured video, a machine representation of the performed one or more steps. The machine representation characterizes the performed one or more steps in a manner and format suitable for computer processing.

In embodiments, processing system 103 is configured to, prior to providing the captured video to frame feature extractor 107, determine a region of interest in the captured video. In embodiments, the region of interest is identified on the basis of a position of one or more identified objects. In embodiments, the region of interest is identified on the basis of a position in the captured video of the user's hands. It may be that the region of interest is identified by determining an area of the captured video in which the user's hands are located for a certain/significant proportion of the duration of the video. A significant proportion may be one that is greater than a pre-determined threshold.

In embodiments, determining a region of interest comprises performing hand detection and tracking on the captured video. In embodiments, the region of interest, for example only the region of interest, is provided to frame feature extractor 107. Thus, in such embodiments, the machine representation is generated from the region of interest. Generating the machine representation from the region of interest reduces the amount of data to be processed, and therefore the processing resources required to generate the machine representation.

In embodiments, processing system 103 is configured to, prior to providing the captured video to frame feature extractor 107, determine a key moment (or key moments) in the captured video. A key moment comprises a period of the captured video during which the one or more steps occur. In embodiments, a key moment is identified on the basis of the presence and/or position of the user's hands. In embodiments, a key moment is identified by determining a period of the captured video during which the user's hands are moving. Additionally or alternatively, it may be that a key moment is identified by determining a period of the captured video during which the user's hands are present in the video (e.g. a period during which the user's hands are within the field of view of camera 101). It will be appreciated that, in many cases, a key moment will comprise a period of the video of shorter length than the captured video. In embodiments, a key moment, for example only the key moment, is provided to frame feature extractor 107. Thus, in such embodiments, the machine representation is generated from the key moment. Generating the machine representation from a key moment reduces the amount of data to be processed, and therefore the processing resources required to generate the machine representation. It will be appreciated that processing system 103 may be configured to determine both a region of interest and a key moment, for example a region of interest within a key moment (or vice-versa).

Processing system 103 further comprises a similarity search function 111. Similarity search function 111 is configured to receive the generated machine representation, and to compare the generated machine representation to a corpus of one or more pre-existing machine representations, the one or more pre-existing machine representations corresponding to one or more pre-existing videos. In embodiments, the corpus of pre-existing machine representations is stored in data storage 113. Alternative embodiments comprise an additional separate data storage unit for storing the corpus. It will be appreciated that one or both of data storage 113 and the additional data storage may be provided by a remote computing resource, for example a remote server or a cloud computing service. In embodiments, each of the pre-existing videos corresponds to a single one of the pre-existing machine representations. In alternative embodiments, a single pre-existing video may correspond to multiple pre-existing machine representations. Similarity search function 111 is configured to, on the basis of the comparison, identify at least one pre-existing machine representation in the corpus which has a similarity relationship with the generated machine representation. In embodiments, the one or more pre-existing videos include videos previously captured by camera 101. In embodiments, all of the one or more pre-existing videos were previously captured by camera 101. In embodiments, the one or more pre-existing videos include a previously captured video of the user preparing food. In embodiments, all the one or more pre-existing videos comprise previously captured video of the user preparing food. Thus, in embodiments, the corpus may be limited to machine representations corresponding to the user's own videos. In such embodiments, system 100 can enable a user to monitor the progression of their cooking abilities by reviewing past videos of themselves performing a given one or more steps of food preparation. Such embodiments can also enable a user to view one or more previously captured videos of themselves performing one or more steps of food preparation to guide the performance of those steps at the present time (for example, in an attempt to reproduce the previously achieved result). Thus, system 100 may, in such cases, act as a kind of performance tracker for a user's cooking ability and allow a user to synchronize their current food preparation steps with food preparation steps they have performed previously.

In embodiments, the similarity relationship comprises one or more vector based similarity measures. Vector based similarity measures are well known to those skilled in the art. Common examples of vector based similarity measures include cosine similarity, Euclidean distance, and Manhattan distance.

In embodiments, comparing the generated machine representation to a pre-existing machine representation comprises calculating a dot product of the generated machine representation and the pre-existing machine representation. Comparing machine representations by calculating a dot product of the two machine representations is a quick and computationally efficient means of determining a measure of the similarity of the machine representations.

In embodiments, similarity search function 111 is configured to further identify a subsection of the at least one pre-existing video. In some cases, it may be the case that the generated machine representation has a similarity relationship to a shorter subsection of a longer video. Identifying a subsection of the at least one pre-existing video allows similarity search function to identify a particularly relevant subsection of the pre-existing video. Thus, such embodiments can be said to synchronize a pre-existing video to the captured video, such that the captured video and the identified subsection of the pre-existing video show corresponding steps in the preparation.

In embodiments, system 100 is configured to operate in one of two modes, the two modes comprising a “recipe mode” and a “free form mode”. In embodiments, similarity search function is configured to receive an indication of a mode of operation of system 100. In embodiments, when operating in the “recipe mode”, similarity search function 111 is configured to receive an indication of a recipe. Providing similarity search function 111 with an indication of a recipe allows the corpus of pre-existing machine representations to be restricted to only those that correspond (or have a certain degree of commonality) to the same recipe. Thus, in embodiments, similarity search function 111 is configured to receive an indication of a recipe being performed by the user. In embodiments, one or more of camera 101, processing system 103, and display 105 is configured to receive user input from the user, the user input indicating the recipe. In embodiments, when operating in the “free form mode”, similarity search function 111 is not provided with an indication of a recipe being performed. Thus, in the “free form mode”, the corpus is not restricted to videos corresponding to a particular recipe.

In embodiments processing system 103 is configured to generate from the one or more pre-existing videos the one or more pre-existing machine representations. In embodiments, processing system 103 is configured to generate the one or more pre-existing machine representations prior to the capturing of the video. In embodiments, processing system 103 may be configured to generate the pre-existing machine representations as a background task. It will be understood by a person skilled in the art that a background task is one which is performed during periods of time in which processing system 103 is idle or in which a portion of its processing capacity which is in use is below a predetermined threshold. In embodiments, the corpus is stored in a separate data storage device. In alternative embodiments, an additional separate processing system is configured to generate the one or more pre-existing machine representations.

Display 105 is configured to facilitate playback to the user of at least one pre-existing video corresponding to the identified at least one pre-existing machine representation. In embodiments, display 105 is configured to facilitate playback of a single pre-existing video. In such embodiments, the single pre-existing video may be selected to correspond to a maximally similar one of the identified pre-existing machine representations. In embodiments, display 105 is configured to facilitate playback of multiple pre-existing videos. Facilitating playback to the user of the at least one pre-existing video corresponding to the identified at least one pre-existing machine representation allows system 100 to provide the user with instructional video content that is relevant to the user's current activity in the preparation.

In embodiments, display 105 is configured to facilitate playback of a further identified subsection of a pre-existing video. Facilitating playback of a further identified subsection of a pre-existing video allows system 100 to present the user with particularly relevant subsections of longer videos. For example, a user encountering difficulty with a particular stage of a recipe is unlikely to want to watch a video of the entire recipe. Rather, the user is simply seeking instruction on the particular stage with which they are struggling. Facilitating playback of a further identified subsection allows system 100 to present the user with only the relevant subsection of the video (in this case, that relating to the user's current stage of the recipe).

It will be appreciated by a person skilled in the art that facilitating playback may, for example, comprise presenting one or more icons or thumbnails to the user, the one or more icons or thumbnails corresponding to the at least one pre-existing video. A user may subsequently select one or more of the icons or thumbnails in order to initiate playback of the corresponding at least one pre-existing video. In embodiments, playback of the at least one pre-existing video may be initiated in response to user input from the user. In embodiments, playback of the at least one pre-existing video may be initiated in response to detection of a voice command spoken by the user. Such a voice command or user input may identify a pre-existing video to be played. Alternatively, such a voice command or user input may comprise a command to play each of the at least one pre-existing videos in turn. Alternatively or additionally, facilitating playback may comprise initiating playback of the at least one pre-existing video. In embodiments, playback of the at least one pre-existing video is initiated automatically following the identification of the at least one pre-existing video. Where more than one pre-existing video is identified, playback of the identified pre-existing videos may be initiated in sequence. Where multiple pre-existing videos are identified, the multiple pre-existing videos may be ranked according to a measure of the similarity of the corresponding pre-existing machine representation to the generated machine representation and presented to the user and/or played back in order of rank.

Prior to a request by a user to system 100 for assistance, processing system 103 is provided with one or more pre-existing videos, from which it generates one or more pre-existing machine representations. In embodiments, processing system 103 generates a single pre-existing machine representation for each of the provided pre-existing videos. In alternative embodiments, processing system 103 generates a plurality of pre-existing machine representations from a single pre-existing video. The pre-existing machine representations comprise a corpus. In embodiments, processing system 103 generates the pre-existing machine representations as a background task, when processing system 103 is otherwise idle or under a reduced load.

In embodiments, users of other instances of system 100 may have individual cameras 101 and displays 105, but may share a joint processing system 103. Thus, in such embodiments, processing system 103 may comprise a cloud computing resource configured to service a plurality of users.

In embodiments, the pre-existing videos are sourced from the users of other instances of system 100. In embodiments, camera 101 is configured to record a session of food preparation. Camera 101 is configured to perform such recording in response to a detection of a ‘Record’ command by the user. In embodiments, the command comprises the user providing user input on camera 101 or display 105. In embodiments, the command comprises a predetermined phrase spoken by the user. The session may comprise performance of an entire recipe or a subsection thereof. The user can choose to upload a recorded session for the benefit of other users. In embodiments, the recorded session is uploaded, for example over the interne, to a remote server. In embodiments, the user may upload the recorded session for storage in data storage 113. Thus, the pre-existing videos may comprise such uploaded sessions, and the corpus may comprise pre-existing machine representations corresponding to such uploaded sessions.

Also prior to a request by a user to system 100 for assistance, in embodiments, machine learning agent 115a, 115b is trained using a plurality of videos of food preparation to perform the functions of one or both of frame feature extractor 107 and sequence feature extractor 109. In embodiments, the training comprises one or both of supervised and unsupervised training.

At a later time, a user preparing food may, during the course of the preparation, encounter difficulty with a particular stage of the preparation and require reassurance or guidance.

In embodiments, camera 101 awaits detection of a trigger event. The trigger event may be detected by camera 101, or an indication of the trigger event having been detected may be provided to camera 101 by another subsystem (for example, display 105). In embodiments, the trigger event comprises a predetermined phrase spoken by the user. In embodiments, the trigger event comprises the user providing user input on camera 101 or display 105.

Camera 101 captures video of the user performing the one or more steps in the preparation. In embodiments, the video is captured in response to detection of the trigger event. Camera 101 transmits the captured video to processing system 103.

Processing system 103 receives the captured video and, in embodiments, determines a region of interest in the captured video. In embodiments, determining a region of interest comprises performing hand detection and tracking on the captured video. In embodiments, processing system 103 crops the captured video to the determined region of interest. It will be understood by a person skilled in the art that subsequent references to the “captured video” include the cropped video.

Processing system 103 receives the captured video into frame feature extractor 107. Frame feature extractor processes individual frames of the video to extract one or more features contained within the frames. In embodiments, frame feature extractor 107 processes every frame of the captured video. In alternative embodiments, frame feature extractor 107 processes a selection of the frames of the captured video. In embodiments, frame feature extractor 107 performs hand detection and/or object detection. Thus, features extracted by frame feature extractor 107 may include one or both hands or a user and one or more objects, for example cooking utensils. Frame feature extractor 107 outputs frame feature data defining the extracted features.

Sequence feature extractor 109 receive the frame feature data and processes it to extract further features from one or more sequences of frames. The sequence may correspond to the entirety of the frame feature data, or to a selection of the frame feature data. By evaluating changes between frame feature data corresponding to frames in the sequence, it is possible to extract movements of the features detected by frame feature extractor 107. In embodiments, sequence feature extractor 109 performs hand and/or object tracking. From those extracted movements, it is possible to determine an action being performed, the action relating to the one or more performed steps. In embodiments, sequence features extractor 109 performs action detection. Thus, in embodiments, features extracted by sequence feature extractor 109 may comprise one or more actions. Sequence feature extractor 109 outputs sequence feature data defining those extracted features. The sequence feature data can be considered to be a machine representation of the performed one or more steps.

Similarity search function 111 receives the generated machine representation, and compares it to the corpus of one or more pre-existing machine representations. In embodiments, the comparing comprises calculating a dot product of the generated machine representation and the pre-existing machine representation. On the basis of the comparison, similarity search function 111 identifies at least one pre-existing machine representation in the corpus which has a similarity relationship with the generated machine representation. In embodiments, the similarity relationship comprises one or more vector based similarity measures.

In embodiments, similarity search function 111 may receive an indication of a recipe being performed by the user. In such embodiments, and where an indication is received, similarity search function 111 limits the corpus to only those pre-existing videos which relate to the specified recipe, constraining the scope of the search problem. In embodiments, the indication may be made by user input from the user on, for example, display 105.

In embodiments, similarity search function 111 further identifies a subsection of the at least one pre-existing video, the subsection having a similarity relationship with the generated machine representation. Thus, similarity search function 111 may identify subsections of videos, in addition to whole videos.

Display 105 receives data from processing system 103 indicating the identified videos, or subsections thereof, and facilitates playback of those videos. Thus, the user is provided with video content that is relevant to the one or more steps in the preparation.

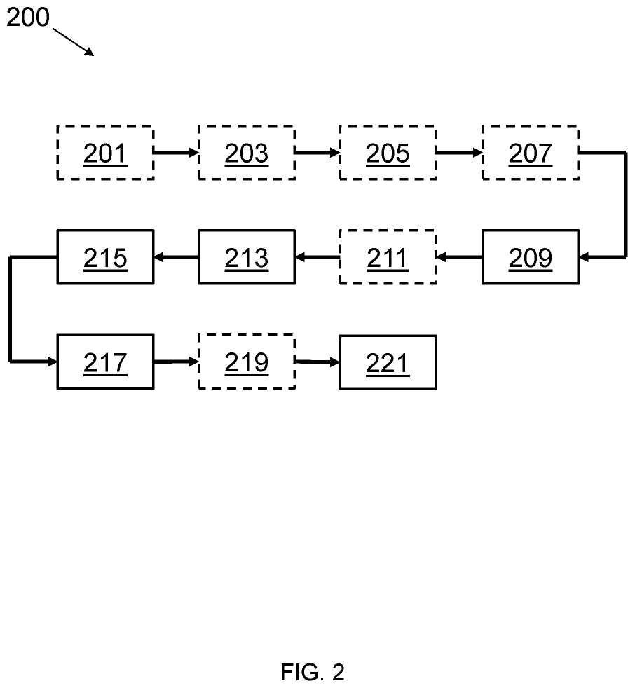

FIG. 2 shows a flow chart illustrating the steps of a method 200 assisting a user in preparation of food according to embodiments of the present disclosure.

An optional first step of the method, represented by item 201, comprises, prior to the capturing, training a machine learning agent using a plurality of videos of food preparation. In embodiments, the training comprises one or both of supervised training and unsupervised training.

An optional second step of the method, represented by item 203, comprises, prior to the capturing, generating from one or more pre-existing videos a corpus of one or more pre-existing machine representations.

An optional third step of the method, represented by item 205, comprises receiving user input from the user, the user input indicating a recipe. In embodiments, the preparation comprises following a recipe.

An optional fourth step of the method, represented by item 207, comprises detecting a trigger event. In embodiments, the trigger event comprises a predetermined phrase spoken by the user. In embodiments, the capturing is performed by a camera and playback is performed by a display. In embodiments, the trigger event comprises the user providing user input on the camera or the display.

A fifth step of the method, represented by item 209, comprises capturing a video of the user performing one or more steps in the preparation. In embodiments, the capturing is performed in response to the detecting.

An optional sixth step of the method, represented by item 211, comprises performing hand detection and tracking on the captured video. Embodiments comprise, on the basis of the hand detection and tracking, determining a region of interest in the captured video.

A seventh step of the method, represented by item 213, comprises generating, from the captured video, a machine representation of the performed one or more steps. In embodiments, the machine representation is generated from the determined region of interest. In embodiments, the generating comprises performing at least one image recognition process on the captured video. In embodiments, the at least one image recognition process comprises one or more of: hand detection and tracking, object detection, action detection. In embodiments, the generating comprises operating the machine learning agent.

An eighth step of the method, represented by item 215, comprises comparing the generated machine representation to the corpus of one or more pre-existing machine representations, the one or more pre-existing machine representations corresponding to the one or more pre-existing videos. In embodiments, the comparing comprises performing a dot product of the generated machine representation and the pre-existing machine representation.

A ninth step of the method, represented by item 217, comprises, on the basis of the comparison, identifying at least one pre-existing machine representation in the corpus which has a similarity relationship with the generated machine representation. In embodiments, the similarity relationship comprises one or more vector based similarity measures.

An optional tenth step of the method, represented by item 219, comprises further identifying a subsection of the at least one pre-existing video. In embodiments, the at least one pre-existing video relates to the indicated recipe.

An eleventh step of the method, represented by item 221, comprises facilitating playback to the user of at least one pre-existing video corresponding to the identified at least one pre-existing machine representation. In embodiments, the facilitating playback comprises facilitating playback of the further identified subsection.

Whilst the present disclosure has been described and illustrated with reference to particular embodiments, it will be appreciated by those of ordinary skill in the art that the present disclosure lends itself to many different variations not specifically illustrated herein. By way of example only, certain possible variations will now be described.

Whilst embodiments of the present disclosure have been described in relation to food preparation, a person skilled in the art will appreciate that embodiments are applicable to the assisting in the performance of tasks more generally. Examples of tasks to which the present disclosure is applicable include: a golf swing, a vehicle maintenance operation, and a dance routine.

Embodiments comprise a method of assisting a user in the execution of a task, the method comprising: capturing a video of the user performing one or more steps in the execution; generating, from the captured video, a machine representation of the performed one or more steps; comparing the generated machine representation to a corpus of one or more pre-existing machine representations, the one or more pre-existing machine representations corresponding to one or more pre-existing videos; on the basis of the comparison, identifying at least one pre-existing machine representation in the corpus which has a similarity relationship with the generated machine representation; and facilitating playback to the user of at least one pre-existing video corresponding to the identified at least one pre-existing machine representation.

Processing system 103 may comprise one or more processors and/or memory. Each device, module, component, machine or function as described in relation to any of the examples described herein, for example the camera 101 or display 105 may similarly comprise a processor or may be comprised in apparatus comprising a processor. One or more aspects of the embodiments described herein comprise processes performed by apparatus. In some examples, the apparatus comprises one or more processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also extend to computer programs, particularly computer programs on or in a carrier, adapted for putting the above described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

The one or more processors of processing system 103 may comprise a central processing unit (CPU). The one or more processors may comprise a graphics processing unit (GPU). The one or more processors may comprise one or more of a field programmable gate array (FPGA), a programmable logic device (PLD), or a complex programmable logic device (CPLD). The one or more processors may comprise an application specific integrated circuit (ASIC). It will be appreciated by the skilled person that many other types of device, in addition to the examples provided, may be used to provide the one or more processors. The one or more processors may comprise multiple co-located processors or multiple disparately located processors. Operations performed by the one or more processors may be carried out by one or more of hardware, firmware, and software.

Data storage (or ‘memory’) 113 may comprise one or both of volatile and non-volatile memory. Data storage 113 may comprise one or more of random access memory (RAM), read-only memory (ROM), a magnetic or optical disk and disk drive, or a solid-state drive (SSD). It will be appreciated by the skilled person that many other types of memory, in addition to the examples provided, may be used to store the captured video. It will be appreciated by a person skilled in the art that processing system 103 may comprise more, fewer and/or different components from those described.

The techniques described herein may be implemented in software or hardware, or may be implemented using a combination of software and hardware. They may include configuring an apparatus to carry out and/or support any or all of techniques described herein. Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program. The carrier may comprise a computer readable storage media. Examples of tangible computer-readable storage media include, but are not limited to, an optical medium (e.g., CD-ROM, DVD-ROM or Blu-ray), flash memory card, floppy or hard disk or any other medium capable of storing computer-readable instructions such as firmware or microcode in at least one ROM or RAM or Programmable ROM (PROM) chips.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the present disclosure that are described as preferable, advantageous, convenient or the like are optional and do not limit the scope of the independent claims. Moreover, it is to be understood that such optional integers or features, whilst of possible benefit in some embodiments of the present disclosure, may not be desirable, and may therefore be absent, in other embodiments.

What is claimed is:

1. A method of assisting a user in preparation of food, the method comprising:
capturing a video of the user performing one or more steps in the preparation;
generating, from the captured video, a machine representation of the performed one or more steps;
comparing the generated machine representation to a corpus of one or more pre-existing machine representations, the corpus of one or more pre-existing machine representations corresponding to one or more pre-existing videos;
based on the comparing, identifying at least one pre-existing machine representation in the corpus of one or more pre-existing machine representations that has a similarity relationship with the generated machine representation; and
facilitating playback to the user of at least one pre-existing video corresponding to the identified at least one pre-existing machine representation.

2. The method of claim 1, wherein the generating comprises performing hand detection and tracking on the captured video.

3. The method of claim 2, comprising, based on the hand detection and tracking, determining a region of interest in the captured video and wherein the machine representation is generated from the region of interest.

4. The method of claim 1, comprising detecting a trigger event, and wherein the capturing is performed in response to the detecting.

5. The method of claim 4, wherein the trigger event comprises a predetermined phrase spoken by the user.

6. The method of claim 4, wherein the capturing is performed by a camera and playback is performed by a display, and wherein the trigger event comprises the user providing user input on the camera or the display.

7. The method of claim 1, wherein the generating comprises performing at least one image recognition process on the captured video.

8. The method of claim 7, wherein the at least one image recognition process comprises one or more of: hand detection and tracking, object detection, action detection.

9. The method of claim 1, wherein, the preparation comprises following a recipe and the at least one pre-existing video relates to the recipe.

10. The method of claim 9, comprising receiving user input from the user, the user input indicating the recipe.

11. The method of claim 1, comprising further identifying a subsection of the at least one pre-existing video, and wherein the facilitating playback comprises facilitating playback of the subsection.

12. The method of claim 1, wherein the similarity relationship comprises one or more vector based similarity measures.

13. The method of claim 1, wherein the generating comprises operating a machine learning agent.

14. The method of claim 13, comprising, prior to the capturing, performing supervised training of the machine learning agent using a plurality of videos of food preparation.

15. The method of claim 13, comprising, prior to the capturing, performing unsupervised training of the machine learning agent using a plurality of videos of food preparation.

16. The method of claim 1, comprising, prior to the capturing, generating from the one or more pre-existing videos the corpus of one or more pre-existing machine representations.

17. The method of claim 1, wherein the one or more pre-existing videos include a previously captured video of the user preparing food.

18. The method of claim 17, wherein all of the one or more pre-existing videos comprise previously captured video of the user preparing food.

19. The method of claim 6, wherein the one or more pre-existing videos include videos previously captured by the camera.

20. The method of claim 19, wherein all of the one or more pre-existing videos were previously captured by the camera.

21. A system for assisting a user in preparation of food, the system comprising:
a camera, configured to capture a video of the user performing one or more steps in the preparation;
at least one processor;
at least one memory including computer program code, the at least one memory and the computer program code being configured to, with the at least one processor, cause the system to:
generate, from the captured video, a machine representation of the performed one or more steps;
compare the generated machine representation to a corpus of one or more pre-existing machine representations, the corpus of one or more pre-existing machine representations corresponding to one or more pre-existing videos; and
based on the comparison, identify at least one pre-existing machine representation in the corpus of one or more pre-existing machine representations that has a similarity relationship with the generated machine representation; and
a display, configured to facilitate playback to the user of at least one pre-existing video corresponding to the identified at least one pre-existing machine representation.

22. A non-transitory computer-readable storage medium having computer-readable instructions stored thereon, the computer-readable instructions being executable by a computerized device to cause the computerized device to perform a method of assisting a user in preparation of food, the method comprising:
capturing a video of the user performing one or more steps in the preparation;
generating, from the captured video, a machine representation of the performed one or more steps;
comparing the generated machine representation to a corpus of one or more pre-existing machine representations, the corpus of one or more pre-existing machine representations corresponding to one or more pre-existing videos;
based on the comparing, identifying at least one pre-existing machine representation in the corpus of one or more pre-existing machine representations that has a similarity relationship with the generated machine representation; and
facilitating playback to the user of at least one pre-existing video corresponding to the identified at least one pre-existing machine representation.
